(19) United States
(12) Patent Application Publication
(10) Pub. No.: US 2010/0267390 A1
(43) Pub. Date: Oct. 21, 2010

(54) Fault-tolerant, multi-network detour router system for text messages, data, and voice

(76) Inventors: Gao Lin, Richmond Hill (CA); Lan Tao Chen, Toronto (CA); Rainer Von Konigslow, Toronto (CA)

Correspondence Address: RAINER VON KONIGSLOW, PHD, 15 YORK VALLEY CR., TORONTO, ON, M2P 1A8, CA

(21) Appl. No.: 12/204,783

(22) Filed: Sep. 4, 2008

(51) Int. Cl. H04W 40/00; H04W 4/12

(52) U.S. Cl. 455/445; 455/466

(57) ABSTRACT

The invention provides a method and system for fault-tolerant communication. It utilizes three wide area networks, including the cell phone network, the internet and the telephone network (PSTN). The method and system monitors the wide-area networks and sends warning messages if they cannot be accessed from a local site. Primary failure conditions relate to the access and use of the three wide-area networks. Secondary failure conditions include power outages. The possible fault conditions include: ‘telephone out’, ‘internet out’, ‘wireless radio out’, ‘power out’. If these failure conditions are detected, the method and system alerts the user and redirects voice, text message, and data traffic via a detour over a different wide-area network in order to avoid that failure.

A method and system has been disclosed that routs information over one of multiple networks in a fault-tolerant manner. In case of network failure, detour routers allow the start-detour routers to switch the information flow over another network to an end-detour router, where the information flow is switched back to the originally-intended network. Cell radios are utilized, as well as telephones and the internet to provide redundancy and fail-over under ‘telephone out’, ‘internet out’, ‘cell phone out’ conditions. The method has particular strengths in supporting communication even with dynamically assigned addresses, thus assuring that remote users receive monitoring and alarm information in a timely manner.

### BACKGROUND OF THE INVENTION

This invention makes an improvement in the field of information technology and communication, and more specifically in the routing of information in a fail-safe manner over multiple networks. The primary application is for monitoring and control. The improvement relates to the fault-tolerant nature of the communication for applications where this aspect is critical, such as for security and for medical monitoring.

### PRIOR ART

Routers and modems for access to the internet, house wiring providing access to switches for the public switched telephone network (PSTN), and wireless access to cell phone networks do not address the problem of what to do when access to these wide area networks fails at a specific local site. No backup or alternative is provided. This invention addresses this backup or alternative access problem for private residences and small establishments.

IP with data packets, TCP, UDP
IP Routers, network address translation (NAT), and Proxy
IP tunneling and virtual private networks (VPN)

### Dynamic Host Control Protocol (DHCP)

public switched telephone network (PSTN) with switches and PBX
Cellular telephone networks including GSM, SMS, and GPRS/Edge

### OBJECTIVES AND ADVANTAGES

This invention arises from the need to provide monitoring services to specific sites such as a home, an office, or a warehouse. The monitoring may be medical or security oriented. The monitoring may report events, it may respond to a status query, or it may relate to the remote control of local devices. Status and event reports may include potential security violations, the operation of equipment, or the heart-rate of individuals at those locations. The monitoring may lead to alarms and data that must be conveyed to other individuals or equipment at remote locations. It may also involve voice communication. This communication must be fast and fail-safe, since time may be of the essence to avoid major problems. The remote individuals may be mobile. More than one such individual or system may need to be notified.

### The Drawbacks of Traditional Security and the Components of a Traditional Communication System

Monitoring equipment and security panels traditionally rely on a single wide-area network for the communication, including the telephone, the internet or a cell phone radio.

Generally, routers are not designed to be fail-safe, i.e. to continue when there is a failure in accessing the wide-area communication network to which they are attached. Access to the local site from remote sites can also be disrupted if the address of the local site is changed suddenly and without notification. This problem typically arises when an internet service provider gives the local site a dynamic address.

### Fail-Safe and Fault-Tolerant Communication

Security, medical, and other forms of monitoring should be fail-safe, i.e. have alternative and back-up channels of communication so that a failure in a single piece of equipment or channel of communication cannot prevent the successful communication of monitoring information. Users, alarm centres and/or maintenance should be notified automatically and immediately. Additionally, users and/or systems may need to contact and control the monitoring equipment from remote locations. Therefore, this externally initiated communication should also be fail-safe.

The causes for alarms and communication failures may require individuals to telephone services such as 911 or maintenance, so that telephone communication should also be fail-safe. On receiving alarms, remote individuals may need to contact individuals at the local site to alert them and possibly to provide instructions. This externally initiated communication should therefore also be fail-safe.

The achievement of truly fail-safe operations is a very difficult goal, especially for low-cost operations. However, operations can be made relatively fault-tolerant by providing redundancy. This kind of fault tolerance is typically applied to equipment but not to access and use of wide-area networks.

The multi-network detour router system described here provides this required level of fault-tolerant communication as follows:
by utilizing multiple diverse wide-area networks
by automatically switching from one network to another on detecting failure conditions
by frequently monitoring for potential failure conditions and by automatically sending notification of failure conditions

The advantage of this multi-network detour router system is that discontinuities in monitoring are avoided, and that the probability of missed alarms is greatly reduced.

### SUMMARY

The invention provides a method and system for fault-tolerant communication. Voice, text messaging, and data are supported. It utilizes three wide area networks, including the cell phone network, the internet and the telephone network (PSTN). The method and system monitors the wide-area networks and sends warning messages if they cannot be accessed from a local site. Primary failure conditions relate to the access and use of the three wide-area networks. Secondary failure conditions include power outages. The possible fault conditions include: ‘telephone out’, ‘internet out’, ‘cell phone out’, ‘power out’. If these failure conditions are detected, the method and system alerts the user and redirects voice, text message, and data traffic via a detour over a different wide-area network in order to avoid that failure. The probability of a failure in communication is thus greatly decreased.

### DRAWINGS

### Figures

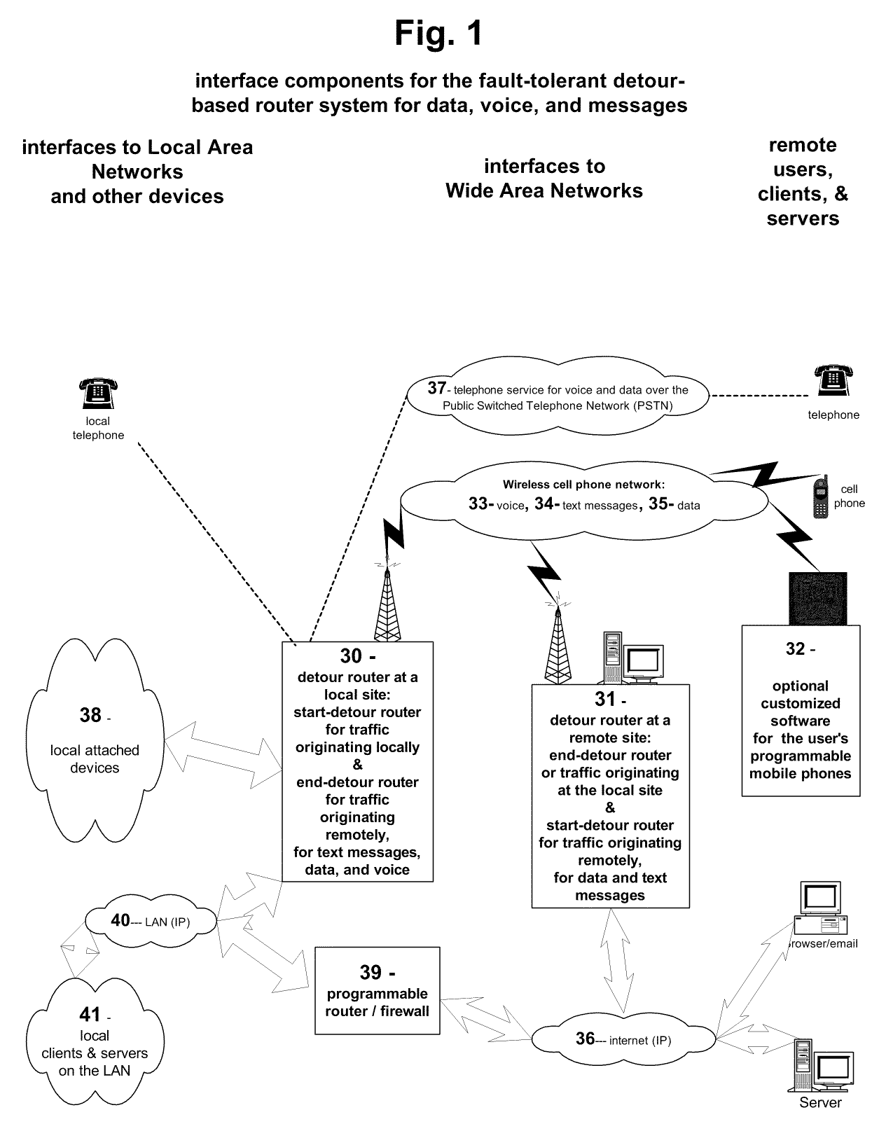

FIG. 1 shows interface components for the fault-tolerant detour-based router system for data, voice, and messages

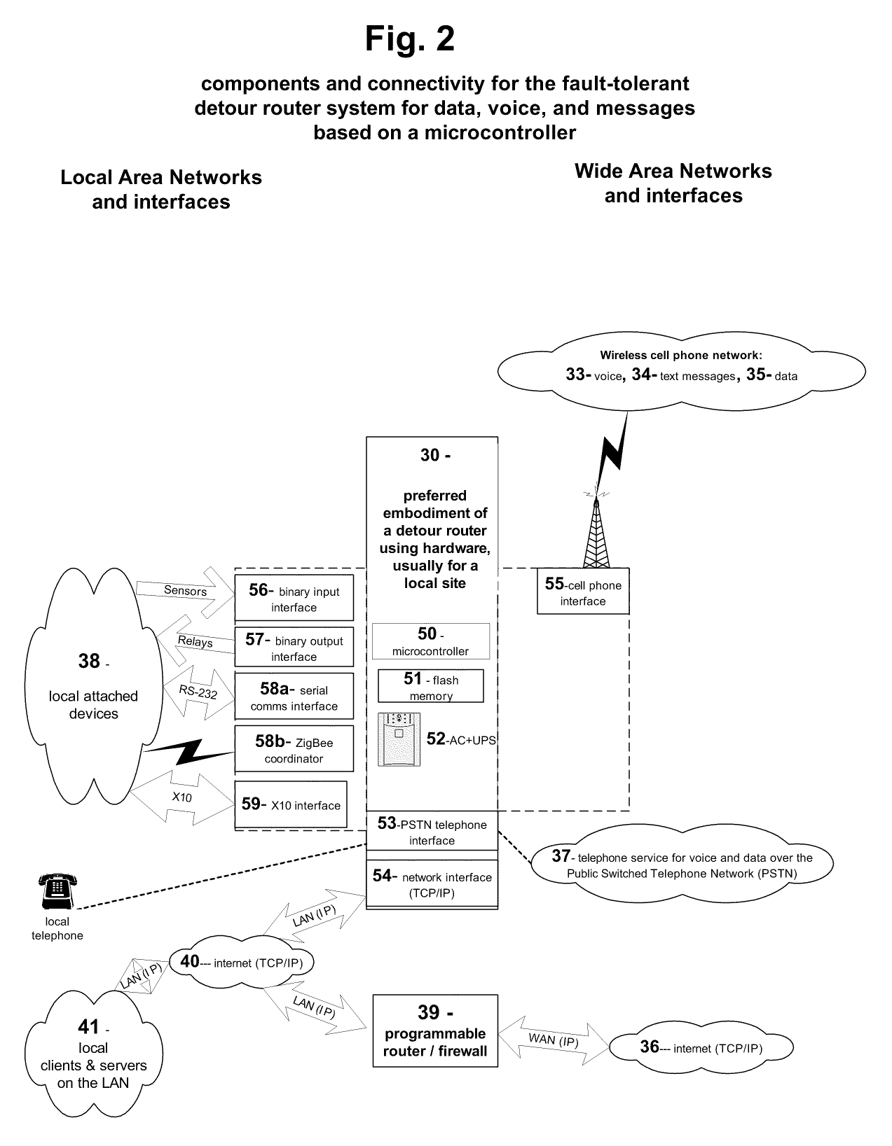

FIG. 2 shows components and connectivity for the fault-tolerant detour router system for data, voice, and messages based on a microcontroller

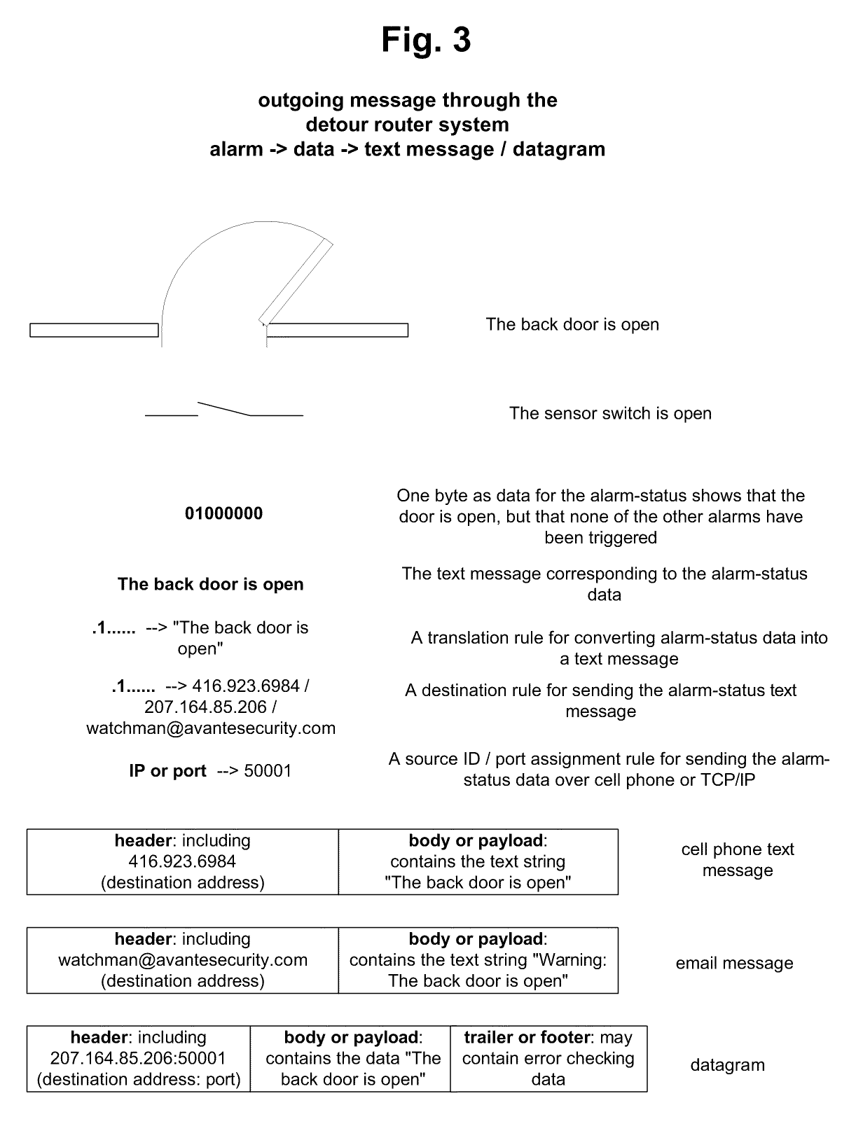

FIG. 3 shows an outgoing message through the detour router system: alarm->data->text message/datagram

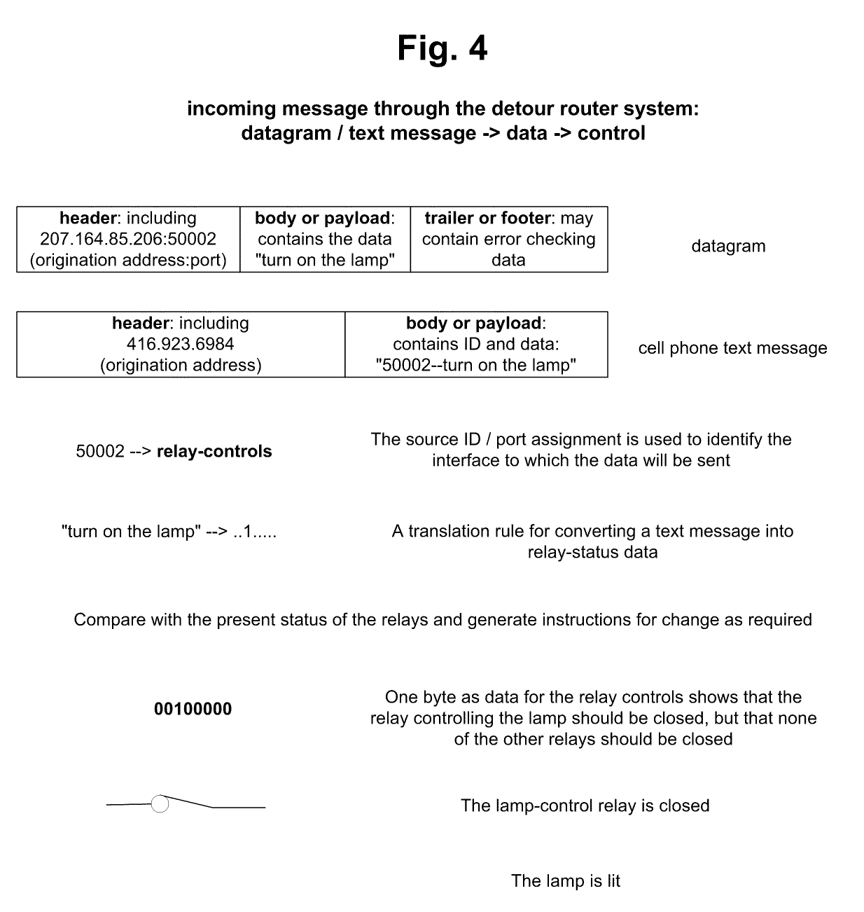

FIG. 4 shows an incoming message through the detour router system: datagram/text message->data->control

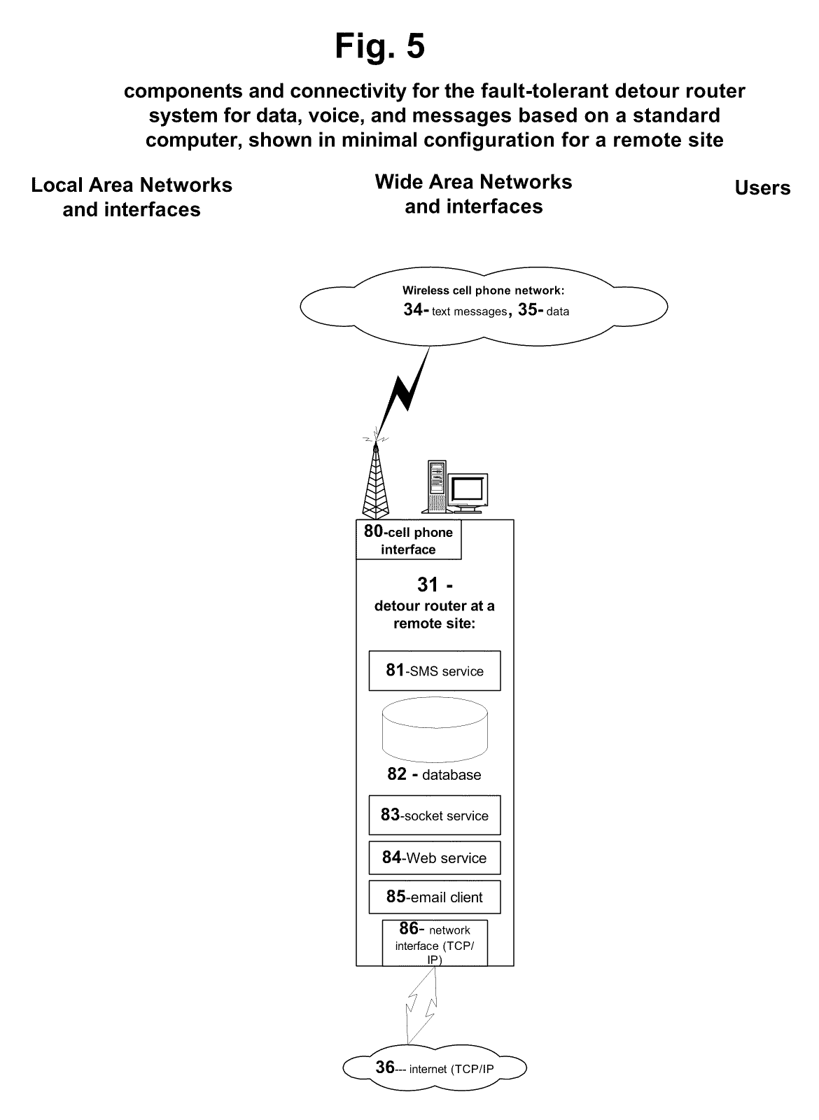

FIG. 5 shows components and connectivity for the fault-tolerant detour router system for data, voice, and messages based on a standard computer, shown in minimal configuration for a remote site

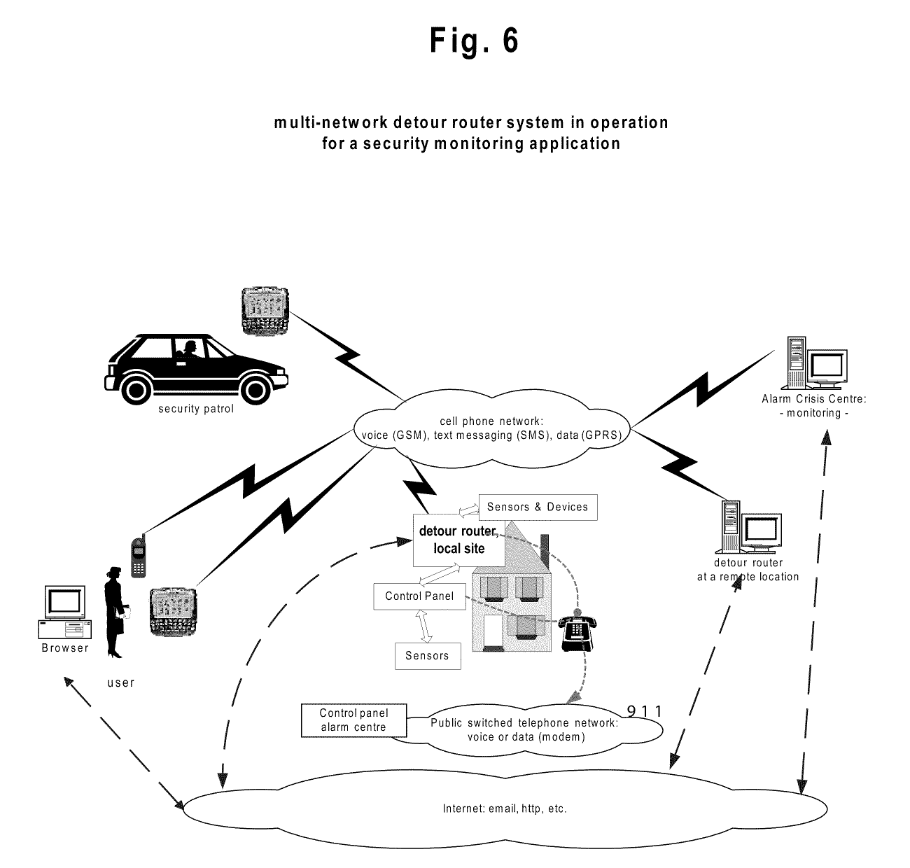

FIG. 6 shows a multi-network detour router system in operation for a security monitoring application

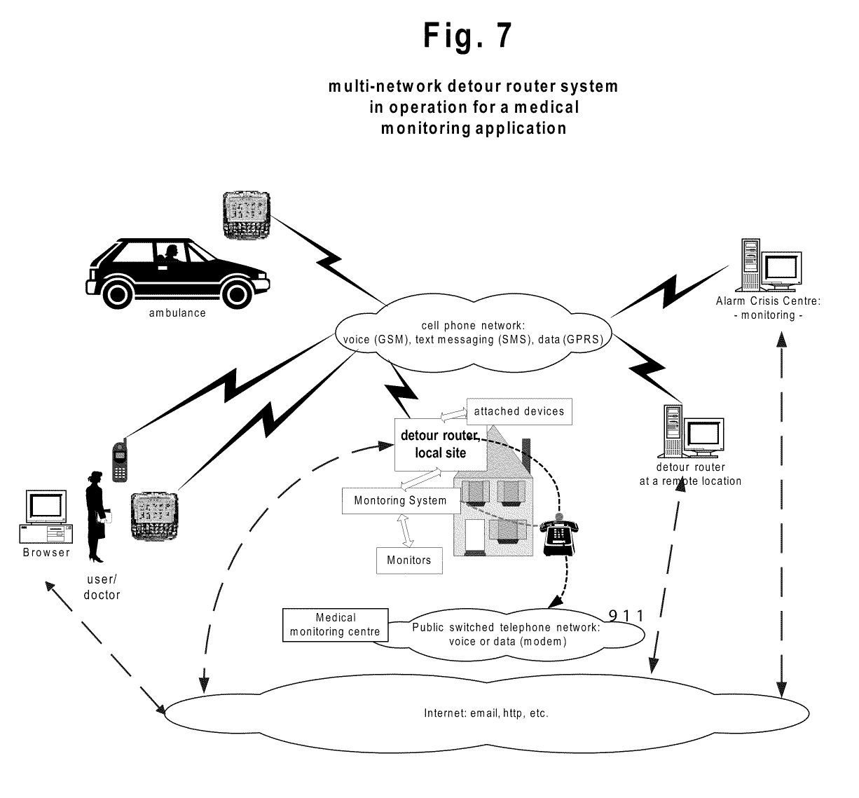

FIG. 7 shows a multi-network detour router system in operation for a medical monitoring application

### REFERENCE NUMERALS

### FIG. 1

30—detour router at a local site: start-detour router for traffic originating locally & end-detour router for traffic originating remotely, for text messages, data, and voice—a system composed of hardware and firmware to run the detour methods in order to provide fault-tolerant routing of text messages, data and voice
31—detour router at a remote site: end-detour router for traffic originating at the local site & start-detour router for traffic originating remotely, for data and text messages: shared resources on the networks for GPRS, SMS, and Web. The service typically consists of software running on a server at a central location to support a number of start-detour routers. The service requires SMS and GPRS communication with a wireless cell phone radio. The service requires access to the internet.
32—optional customized software for the user's programmable mobile phones
33—Voice connection service over the wireless cell phone network
34—Text messaging service over the wireless cell phone network such as SMS
35—Data transmission service over the wireless cell phone network such as GPRS
36—The public internet
37—telephone service for voice and data over the Public Switched Telephone Network (PSTN)
38—local attached devices: local data networks and connections supporting a variety of devices connected to the detour router in order to take advantage of fail-safe routing of data
39—programmable router/firewall—for internet traffic
40—LAN—local area network for an intranet (IP)
41—Local clients and servers, with local fixed addresses on the LAN

### FIG. 2

50—The microcontroller running firmware for the detour router (30)
51—The flash memory used to hold non-volatile data for the detour router (30)
52—The power supply and battery backup for the detour router (30)
53—The telephone interface, normally connecting the house phone to the PSTN, but switching to the cell phone when the PSTN is out
54—The TCP/IP network interface for controlling the programmable router, controlling local devices on the LAN, and for sending and receiving messages through the internet
55—The local cell phone interface, supporting voice, text messaging (e.g., SMS), and data transmissions (e.g., GPRS)
56—The binary input interface from local devices such as sensors
57—The binary output interface to local devices through relays
58a—either a serial comms interface (RS232) to some local device,
58b—or a ZigBee coordinator for a wireless network connection to local devices
59—an X10 interface

### FIG. 5

80—The remote service cell phone interface, supporting text messaging (e.g., SMS), and data packet transmissions (e.g., GPRS)
81—SMS service: the text messaging interface between the detour router at the local site and the end-detour router at the remote site, as well as between the user's cell phone SMS and the detour router at the remote site
82—database: equivalent to the flash memory (51), contains customized software for the user's programmable mobile units, and contains information for translating rules
83—socket service: the data interface between the detour router at the remote site, and the detour router at the local site or the remote client and server
84—Web service: an interface for browsers, to receive status and other information from the start-detour router, and to use forms to manage both the end-detour router (through the database), the start-detour router (primarily through the flash memory), and local devices attached to the start-detour router.
85—email client: for sending emails to the user's remote devices, both mobile and otherwise, based on messages received from the start-detour router.
86—The TCP/IP network interface for sending datagrams through the internet

### DETAILED DESCRIPTION

### Preferred Embodiment

### FIGS. 1-4

The invention provides a method and system for fault-tolerant communication. It utilizes three wide area networks, including the cell phone network, the internet and the telephone network (PSTN). The method and system monitors the wide-area networks and sends warning messages if they cannot be accessed from a local site. Primary failure conditions relate to the access and use of the three wide-area networks. Secondary failure conditions include power outages. The possible fault conditions include: ‘telephone out’, ‘internet out’, ‘wireless radio out’, ‘power out’. If these failure conditions are detected, the method and system alerts the user and redirects voice, text message, and data traffic via a detour over a different wide-area network in order to avoid that failure. In the preferred embodiment, the method and system is relatively inexpensive to implement, and uses dedicated hardware with a micro controller and firmware. As alternate embodiment, the method and system is implemented with a standard personal computer with add-on boards or plug-ins.

As shown in FIG. 1, the multi-network detour router method and system is comprised of two components: a detour router at the local site, and a detour router at a remote site. A detour router can function both as start-detour router and as end-detour router depending on where the traffic originates. Optionally, there is software for the mobile units of remote users.

The ‘multi-network detour router system’ refers to the two detour router components. The ‘detour router at a local site’ (30) illustrates the detour router embodied as dedicated hardware with a micro controller and with its firmware. The ‘end-detour router at a remote site’ (31) illustrates the alternate embodiment. The ‘optional customized software’ (32) refers to the custom software on a programmable mobile that supports detour routing functionality but is not required.

The system and its two components utilize eight methods.

The eight methods are as follows:
a. A method and system for using a text message over a cell phone network for interfacing between a remote device and data from and to local devices.
b. A method and system for detour routing of an outgoing text message to avoid failure in cell phone access.
c. A method and system for detour routing of an incoming text messages from the remote user's cell phone to avoid failure.
d. A method and system for detour routing of an exchange of datagrams from a local client on a local area network to a remote server on the internet over the cell phone data network
e. A method and system for detour routing of an exchange of datagrams initiated by a remote client on the internet to a local server
f. A method and system for detour routing of telephone calls from and to local devices connected directly to the public switched telephone network to and from remote users over multiple networks, and under failure conditions
g. A method and system for detour routing of telephone calls from and to local devices connected directly to the public switched telephone network to and from remote users over multiple networks, under failure conditions
h. A method and system for detour routing of telephone calls to local devices connected directly to the public switched telephone network from remote users over multiple networks, under failure conditions

Some methods are only deployed at one site, and some coordinate between both sites, as illustrated in the following table:

| | Traffic | Local site | Remote site | Shared info |
|---|---|---|---|---|
| a | Text | Sending and | Sending and | Notifying remote |
| | message | receiving over | receiving over | user of faults, |
| | | interfaces, detecting | interfaces, tracking | synchronizing |
| | | faults, translating | faults, translating | rules and data |
| | | messages, applying | messages, applying | |
| | | rules from memory, | rules from memory, | |
| | | updating rules in | updating rules in | |
| | | memory from text | memory from text | |
| | | messages | messages | |
| b | Outgoing | Start-detour over | End-detour from | Cell phone # |
| | text | internet | internet to cell | |
| | message | | phone | |
| | over cell | | | |
| | phone | | | |
| c | Incoming | End-detour from | Start-detour from | Local site status |
| | text | internet | cell phone over | and IP address |
| | message | | internet | |
| | over cell | | | |
| | phone | | | |
| d | Outgoing | Detour over cell | | |
| | datagrams | phone | | |
| | from LAN | | | |
| | over internet | | | |
| e | Incoming | End-detour from cell | Start-detour from | Status at local |
| | datagrams | phone to LAN | internet over cell | site, NAT port |
| | to LAN over | | phone | |
| | internet | | | |
| f | Outgoing | Detour over cell | | |
| | voice call to | phone | | |
| | PSTN | | | |
| g | Incoming | Detour over cell | | |
| | voice call | phone | | |
| | from PSTN | | | |
| h | Redirect | Detour over cell | | Redirection rule |
| | incoming | phone | | from remote |
| | voice call | | | user |
| | from PSTN | | | |

These methods are implemented using an inexpensive and flexible hardware structure, as shown in FIG. 2. In the minimal embodiment, the system is based on a minimum of five hardware sub-components including a microcontroller, a persistent memory such as flash or a drive, AC power with UPS, a network (internet) interface, and a cell telephone interface. In the full embodiment, the system also includes a PSTN telephone interface to detour voice calls. Additional device interfaces for this full embodiment include a digital/sensor input interface, a digital/relay output interface, a serial comms interface or a ZigBee wireless interface, and an X10 interface.

A The microcontroller (50), Microchip PIC 18F6722, has 5 interfaces that manage the voice and data traffic through the start-detour router, under the normal condition, under the 4 local failure conditions, and under the remote ‘wireless mobile out’ condition. It has a further 4 interfaces that extend the concept of local-area network beyond the TCP/IP based interfaces to include RS232, X10, ZigBee, as well as sensors and relays.
A.1 The first interface is an 7 bit data interface for the telephone control—for the ‘telephone out’ condition. The telephone interface is described in C below.
   4 bits are connected to the DTMF decoder that extracts telephone numbers dialed under the fail-safe connection for ‘telephone out’ as described in C below. The number is then passed to the radio for dialing for a voice connection.
   1 bit is for the relay that connects the house phone either to PSTN (default) or to the radio.
   1 bit is for telephone line voltage detection—detecting the ‘telephone out’ condition—connected to the PSTN telephone interface described in C. below (53).
   1 bit is for off-hook (53).
A.2 The second interface is a serial peripheral interface (SPI) interface which is connected to the Rabbit microcontroller internet interface (54) described in D below.
   The ‘internet out’ condition is detected by the Rabbit and communicated to the microcontroller.
   The data traffic to and from the internet or LAN.
   Control of the programmable router is managed through this interface.
A.3 The third interface is to the radio (55) described in E. below. It deals with the ‘wireless radio out’ condition.
   A.3a There is a bidirectional serial comms interface (UART).
      The ‘wireless radio out’ condition is detected through this interface.
      SMS data messages to the end-detour router or to users are sent through this interface.
      SMS data messages from the end-detour router or from users are received through this interface.
      Under the ‘telephone out’ condition, voice calls are dialed through this interface as described in C below.
   A.3b There is a 1 bit output line that activates the radio power (reset) switch (55) as one of the methods to recover from the ‘wireless radio out’ condition.
A.4 The fourth interface is a 2 bit data input interface for the ‘power out’ condition. 2 lines are used for detecting the state of power for the start-detour router. One bit is to indicate ‘power down’ for reporting the availability of 12V from an integrated AC power supply, or from an external 12V supply. One bit is to indicate ‘power low’ for reporting the state of a 12V battery that functions as UPS.
   1 bit is for AC power failure (52)—the ‘power out’ condition
   1 bit is for UPS battery low (52)
A.5 The fifth interface is an 2 bit data interface which is connected to the flash memory (51) for reading and writing user information received through the radio as described in B below.
   1 bit is for the clock
   1 bit is for data
A.6 The sixth interface is a second serial comms interface which is connected directly to an external device as described in F.1a below (58a), or it is connected to a ZigBee coordinator as described in F.1b below (58b)
A.7 The seventh interface is a 3 bit interface for X10 (59). One for generating a zero crossing interrupt, one for sending 1 bit of data, and one for receiving 1 bit of data. The interface is connected to the Microchip CCP—X10 module—RJ12->X10 interface at the power line as described in F.2 below
A.8 The eighth interface is an 5 bit input interface—8 data lines in, connected to the digital/sensor input interface described in F.3 below (56)
   3 address bits are for zone selection
   1 bit is for sensing—for zone input
   1 bit is for detecting an open circuit error condition (unused zones must have an unused resistive load)
A.9 The ninth interface is a 9 bit data output interface which is connected to the digital/relay output interface described in F.4 below (57)
3 address bits for zone selection—for relay flip-flop control
   2 bits are for latching, resetting, or for setting a timed latch (57)
   1 bit is for the extra on-board relay (57)
   3 bits are for control of the LEDs on the start-detour router (30) that indicate the status of the start-detour router

B. Data storage is provided with flash memory (51).
B.1 The flash memory records user names, mobile telephone numbers to be contacted, and the type of data encoding to be used, such as SMS or email. It also contains customized labels for the different bits in the binary input and output.
B.2 The reading and writing interface with the microcontroller (50) is described in A.5 above.
B.3 The start-detour router is typically connected to a variety of devices. The specific devices will vary from one location to the next, so along with the user list and particulars, other information on sensor zones and relay controls is maintained both locally in the flash memory and remotely in a database. Each time the database is updated relative to a particular location, the information is downloaded and the flash memory is updated.
   All users entered here are contacted and sent messages when alarms are detected.
   Users entered here are allowed to send control information to the start-detour router.
   Information about the input sensors (zones), including labels, is entered here.
   Information about the control relays, including labels, is entered here.
B.4 Temporary storage as for input and output buffers, and for network translation tables, is provided by the microcontroller itself, and is not persistent over shutdowns and resets.

C. The house phone to PSTN telephone module (47) has two RJ11 plugs connecting to the public network and the house phones respectively.
C.1 The tip and ring lines from the house is normally connected the to the PSTN through a relay.
C.2 If the PSTN is down (voltage low), i.e. the ‘telephone out’ condition, the house phone is automatically connected to the cell phone.
   C.2a If an ‘off-hook’ condition is detected:
      an off-hook sound is generated as appropriate.
      the number dialed is decoded through a DTMF decoder.
      the tip and ring lines go through op amps to send analog audio signals to the microphone in and speaker out connections of the radio.
   C.2b If an incoming voice call is detected by the radio:
      a signal is generated to ring the bell of the house phone for incoming calls from the cell phone.
      The tip and ring lines from the house are connected to the microphone input and speaker output of the radio through op amps
C.3 Under special circumstances (security alarmed, user requested), the PSTN may be automatically connected to the radio. On detecting an incoming ring, the user is automatically dialed through the radio.

D. The internet connection is managed through a Rabbit RCM 3700 family microcontroller (54), that communicates to the local LAN through RJ45.
D.1 The Rabbit microcontroller communicates with the Microchip PIC 18F6722 microcontroller through an SPI interface (A.2), where the PIC 18F6722 is the master and the Rabbit the slave.
   D.1a The ‘internet out’ condition is detected through a mechanism such as pinging the end-detour router, and communicated through this interface.
D.2 The Rabbit is used to control the programmable router acting as gateway between the LAN and the internet (WAN). The rabbit can send control information such as opening and closing specific ports in the firewall embedded in the router.
D.3 Outgoing traffic over the Rabbit is used to control devices connected to the LAN. The rabbit can broadcast (send) control information such as causing a shut-down on the LAN (e.g. in case of building evacuation because of fire alarms). It can also be used to control specific devices.
D.4 Incoming traffic from the LAN is for fail-safe purposes to forward data over GPRS back to the internet. To function as a fail-safe gateway for internet traffic, the Rabbit must be given a fixed IP address on the LAN. This address must be programmed as secondary gateway for selected devices on the LAN, so that it can forward traffic to the GPRS radio if the primary gateway fails.
D.5 Incoming traffic from the WAN may be for controlling local devices or for managing the start-detour router itself.
D.6 Firmware typically is customized to the application.

E. The radio (55) is a GSM/SMS/GPRS/Edge module (Sony/Ericsson GR64—with AT command set) with interfaces to handle voice, SMS text messaging, and GPRS data. It interfaces with a cellular telephone network as arranged by local subscription with a simcard.
E.1 The data and text messaging interface with the microcontroller (50) is through a serial interface (A.3 above) to the ARM-9 processor managing the radio.
E.2 The voice interface with the PSTN telephone is through the analog microphone and speaker interfaces. This interface is enabled when the ‘telphone out’ condition is detected.

F. The specific local devices, and the methods and interfaces for connecting to these devices will vary from one application to another, and within the same type of application, from one location to another. A number of different methods and interfaces are supported for the acquisition and transmission of local data. Similarly, a number of different methods and interfaces are supported for the remote management and control of local devices.
F.1 There are two alternate interfaces with the second UART data interface of the microcontroller (A.6)
   F.1a One option is a serial data interface (RS232 port) (58a) to communicate with a wide range of local equipment that support this interface
   F.1b A second option is a ZigBee wireless interface (58b) to communicate with a wide range of local equipment that support this interface. The microcontroller (50) communicates with the ZigBee coordinator through the serial interface.
F.2 The X10 interface is managed by a Microchip CCP—X10 module (59), with an RJ12 to X10 interface at the power line. The X10 interface communicates with the PIC 18F6722 microcontroller (A.7) through an interrupt for detecting zero crossing on the 60 Hz AC power. This is followed by sending 1 bit of data and/or receiving 1 bit of data.
F.3 The discrete digital/sensor input (56) interfaces with 8 distinct alarms (zones). The circuit uses 3 address bits for selecting one of the zones. The circuit uses 2 bits for sensing: one for open circuit, and one for the binary state of the zone. The 8 zone interfaces must either be connected or terminated with appropriate resistors during the setup to avoid spurious alarms.
F.4 The discrete digital/relay output interfaces with 7 distinct relays (57). The circuit uses 3 address bits for selecting one of the latching flip-flops controlling a corresponding relay. The circuit uses 2 bits for control: one for selecting the state, and one for the timing.

### Operation—Preferred Embodiment, FIGS. 1-6

The invention provides a method and system for fault-tolerant communication. It utilizes three wide area networks, including the cell phone network, the internet and the telephone network (PSTN). The method and system monitors the wide-area networks and sends warning messages if they cannot be accessed from a local site. Primary failure conditions relate to the access and use of the three wide-area networks. Secondary failure conditions include power outages. The possible fault conditions include: ‘telephone out’, ‘internet out’, ‘cell phone out’, ‘power out’. If these failure conditions are detected, the method and system alerts the user and redirects voice, text message, and data traffic via a detour over a different wide-area network in order to avoid that failure. In the preferred embodiment, the method and system is relatively inexpensive to implement, and uses dedicated hardware with a micro controller and firmware. As alternate embodiment, the method and system is implemented with a standard personal computer with add-on boards or plug-ins.

As shown in FIG. 1, the multi-network detour router method and system is comprised of two components: a detour router at the local site, and a detour router at a remote site. A detour router can function both as start-detour router and as end-detour router depending on where the traffic originates. Optionally, there is software for the mobile units of remote users.

The ‘multi-network detour router system’ refers to the two detour router components. The ‘detour router at a local site’ (30) illustrates the detour router embodied as dedicated hardware with a micro controller and with its firmware. The ‘end-detour router at a remote site’ (31) illustrates the alternate embodiment. The ‘optional customized software’ (32) refers to the custom software on a programmable mobile that supports detour routing functionality but is not required.

The system and its two components utilize eight methods.

The eight methods are as follows:
a. A method and system for using a text message over a cell phone network for interfacing between a remote device and data from and to local devices.
b. A method and system for detour routing of an outgoing text message to avoid failure in cell phone access.
c. A method and system for detour routing of an incoming text messages from the remote user's cell phone to avoid failure.
d. A method and system for detour routing of an exchange of datagrams from a local client on a local area network to a remote server on the internet over the cell phone data network
e. A method and system for detour routing of an exchange of datagrams initiated by a remote client on the internet to a local server
f. A method and system for detour routing of telephone calls from and to local devices connected directly to the public switched telephone network to and from remote users over multiple networks, and under failure conditions
g. A method and system for detour routing of telephone calls from and to local devices connected directly to the public switched telephone network to and from remote users over multiple networks, under failure conditions
h. A method and system for detour routing of telephone calls to local devices connected directly to the public switched telephone network from remote users over multiple networks, under failure conditions

Some methods are only deployed at one site, and some coordinate between both sites, as illustrated in the following table:

| | Traffic | Local site | Remote site | Shared info |
|---|---|---|---|---|
| a | Text | Sending and | Sending and | Notifying remote |
| | message | receiving over | receiving over | user of faults, |
| | | interfaces, detecting | interfaces, tracking | synchronizing |
| | | faults, translating | faults, translating | rules and data |
| | | messages, applying | messages, applying | |
| | | rules from memory, | rules from memory, | |
| | | updating rules in | updating rules in | |
| | | memory from text | memory from text | |
| | | messages | messages | |
| b | Outgoing | Start-detour over | End-detour from | Cell phone # |
| | text | internet | internet to cell | |
| | message | | phone | |
| | over cell | | | |
| | phone | | | |
| c | Incoming | End-detour from | Start-detour from | Local site status |
| | text | internet | cell phone over | and IP address |
| | message | | internet | |
| | over cell | | | |
| | phone | | | |
| d | Outgoing | Detour over cell | | |
| | datagrams | phone | | |
| | from LAN | | | |
| | over internet | | | |
| e | Incoming | End-detour from cell | Start-detour from | Status at local |
| | datagrams | phone to LAN | internet over cell | site, NAT port |
| | to LAN over | | phone | |
| | internet | | | |
| f | Outgoing | Detour over cell | | |
| | voice call to | phone | | |
| | PSTN | | | |
| g | Incoming | Detour over cell | | |
| | voice call | phone | | |
| | from PSTN | | | |
| h | Redirect | Detour over cell | | Redirection rule |
| | incoming | phone | | from remote |
| | voice call | | | user |
| | from PSTN | | | |

The first topic in operations concerns the core/basic operations that underly the system, and normal operations when no fault has been detected in any of the wide-area networks connected to the detour router at the local site. The second topic deals with setup and coordination between the detour router at the local site and the detour router at the remote site. The third topic deals with operations in which the interface to the cell phone of the detour router at the local site indicates a fault. The fourth topic deals with operations in which the detour router at the local site is not able to access the internet. The fifth topic deals with operations in which the interface to the PSTN reports a fault. The sixth topic deals with the case in which the user has requested that some or all incoming telephone calls be redirected over the cell phone.

G Basic Operations

Method a relates to the operation of the system under normal operating conditions, i.e. when there are no faults relating to communication over the wide area networks. Under these normal conditions, interfaces for incoming information either use interrupts or are polled for changes in status and for incoming information. Memory and buffers are checked for outgoing information that is pending which is then sent to the appropriate interface.

If there is no change in status and no incoming information and no outgoing information, the system continues polling.

If there is a change in status, or if there is incoming information from an interface, the information is captured into a buffer. The main faults of ‘telephone out’, ‘internet out’, ‘cell phone out’, and ‘power out’ are detected and the user as well as the detour router at the remote site are notified. A rule is retrieved from memory and applied to the processing of the information. In most situations, the information is translated to produce both a text message and one or more addresses. The addresses indicate the interface over which the text message should be sent. When the address received is a telephone number, the text message is sent via the cell phone interface. When the address received is an IP address, the text message is sent as datagram over the internet network interface. When the address received is an email address, the text message is embedded as an email and is then sent as an email message. An interface ID or port number might also be retrieved from the rule and used to help route the information. FIG. 7 illustrates this process for a sensor used in a security application.

When the system detects a change in status, operation of the detour router at the local site is adjusted to cope with any outage. Operation of the detour router at the remote site is also adjusted accordingly.

For text messages coming in over the cell phone interface, a rule is retrieved from memory and applied to translate the text message. Depending on the associated address, the translated information might be sent to a device interface to change the status or to effect some control. Alternately, the information might be used to select and replace (or edit) a rule in memory.

H Setup and Configuration

### Physical Setup

The local devices are customized to suit the local installation and application. Monitoring devices (38) are connected through various interfaces (56, 57, 58a or 58b, 59) to the detour router at the local site (30), or connected through a LAN to a programmable router (39) that is also connected to the detour router at the local site (30).

### Data Setup and Configuration

In the flash memory (51) of the detour router at the local site, each interface to a device is associated with a unique identification (ID). Each of these IDs in turn is associated with a port number that is used for network address translation (NAT). For remote users the devices should also have a static name to make it reachable through the end-detour router. The devices on the LAN also have fixed local IP addresses. The network interface (54) of the detour router at the local site also has an ID and a fixed IP. The programmable router (39) on the LAN also has an ID and a fixed IP for the LAN connection. The table below is an example of such ID, address, and port assignments:

| | | Address: | |
|---|---|---|---|
| Interface/device | ID | LAN/internet/tel # | port |
| Detour router cell phone # - text | 101 | 416-923-6984 | 9001 |
| messaging | | | |
| Detour router cell phone IP address - data | 102 | Dynamic | 9002 |
| Detour router cell phone # - voice | 103 | 416-923-6984 | 9003 |
| PSTN voice | 104 | 416-923-5198 | 9005 |
| detour router LAN interface | 105 | 192.168.0.2 | 9006 |
| Detour router memory for rules | 106 | | 9007 |
| Back door sensor | 107 | | 9008 |
| Lamp relay | 108 | | 9009 |
| Security panel (RS232) | 109 | | 9010 |
| X10 appliance | 110 | | 9011 |
| Router (LAN) | 111 | 192.168.0.1 | 9012 |
| Router (internet) | | Dynamic | |
| Video camera 1 | 112 | 192.168.0.10 | 9013 |

The detour router at the local site is programmed to configure the port assignments for the network address translation of the LAN-to-internet router. The same port assignments are used. Interfaces associated with the detour router are addressed by using the LAN interface of the detour router with the port number for the interface. This port assignment process is customized, but most routers use a simple Web-form approach. It can be automated so that the port assignment can be updated remotely through the detour router with text messages.

The detour router at the local site also has a customized program to periodically and automatically retrieve the current internet address of the router. This address is compared with the currently stored address, and the user as well as the detour router at the remote site are notified of any changes.

The detour router at the local site and the detour router at the remote site share and synchronize the information about interfaces/devices, addresses, and port assignments. If the detour router at the remote site has a static internet address such as “avantesecurity.com”, the static address with the port can be used to exchange information over the internet with devices on the LAN at the local site as well as with devices that interface with the detour router at the local site. The same approach can be used by anyone on the internet to exchange information over the cell phone, assuming the cell phone has a current data session, has communicated the current IP address to the detour router at the remote site, and is using the same port assignment.

### Operation Under Fault Conditions

Below, we describe operations under the failure conditions that invoke the fault-tolerant features of the multi-network detour router system:
‘telephone out’
‘internet out’
‘cell phone out’

J Outgoing text messages originate at the local site, along with the cell phone number for which they are intended. Under normal conditions, and for ‘telephone out’ and ‘internet out’ conditions, they are sent via the text messaging capabilities of the cell phone at the local site.

When there is a ‘cell phone out’ condition affecting the detour router at the local site, the cell phone number is concatenated to the text message, and the resulting string is sent via the internet to the remote site at a specific port. The cell phone number is separated from the text message, and the text message is forwarded to that cell phone number via the cell phone at the remote site.

K Incoming text messages originate externally, typically from the cell phone of a remote user. Under normal conditions, and for ‘telephone out’ and ‘internet out’ conditions, they are received via the text messaging capabilities of the cell phone at the local site.

When there is a ‘cell phone out’ condition affecting the detour router at the local site, the user and the remote site will have been notified. The remote user must send the text message intended for the local site to the cell phone number at the remote site. The remote site forwards the message via the internet to the appropriate port of the LAN-to-internet router. This router will forward the message to the same port of the LAN interface of the detour router at the local site. The detour router recognizes the port and identifies the message as an incoming text message, and processes it accordingly using rules retrieved from memory.

L Outgoing datagrams from the LAN are sent to the LAN-to-internet router as main gateways and processed normally, unless there is an ‘internet out’ condition.

When there is an ‘internet out’ condition affecting the detour router at the local site, the user and the remote site will have been notified. The datagram is sent to the detour router at the local site as secondary gateway. The detour router then forwards the datagram over the cell phone data session, after appropriate network address translation. The cell phone network will route it back to the internet.

M Incoming datagrams from the internet are sent through the LAN-to-internet router and processed normally either by forwarding them to LAN devices or by forwarding them to the detour router using the same port.

When there is an ‘internet out’ condition affecting the detour router at the local site, the user and the remote site will have been notified. Some remote clients, such as a browser, may not have received that notification, or may not have the capacity to process it (e.g. if the remote client is an automated operation). Such remote clients can be set up to request service from the detour router at the remote site. A static IP and a specified port can be used (using the same port assignment). Since the internet is blocked, the remote detour router will send the internet traffic over the cell phone dataservice. The remote detour router can check whether there is a current data exchange session with the cell phone of the detour router at the local site. If so, the request can be added to that stream. If not, a text message can be sent to the detour router at the local site requesting such a session.

N An outgoing voice call from the house phone over the PSTN is processed normally, unless there is a ‘telephone out’ condition.

When there is a ‘telephone out’ condition affecting the detour router at the local site, the user and the remote site will have been notified. The house phone is disconnected from the PSTN and calls are sent over the voice capabilities of the cell phone. ‘Off hook’ is recognized, a dial tone is provided, the number dialed is recognized and sent to the cell phone interface, and the audio media are connected for both directions. ‘On hook’ or the cell phone termination are recognized and processed. The cell phone call is allowed to complete even if the PSTN becomes active again during the call.

O An incoming voice call from the PSTN to the house phone is processed normally, unless there is a ‘telephone out’ condition.

When there is a ‘telephone out’ condition affecting the detour router at the local site, the user and the remote site will have been notified. The house phone is disconnected from the PSTN and calls are sent over the voice capabilities of the cell phone. ‘Off hook’ and ‘on hook’ are recognized. For an incoming call, a ring tone or other notification is provided, and the audio media are connected for both directions.

P An incoming voice call from the PSTN to the house phone are processed normally, unless the user has requested redirection.

When there is a ‘redirection’ condition affecting the detour router at the local site, the user and the remote site will have been notified. The house phone is disconnected from the PSTN and calls are sent over the voice capabilities of the cell phone. ‘Off hook’ and ‘on hook’ are recognized. For an incoming call, the telephone number to be used for redirection is retrieved from a rule and sent to the cell phone interface.

### Additional Embodiments

The invention provides a method and system for fault-tolerant communication under conditions that normally threaten the timely communication of monitoring and alarm information from a local site to remote users. The primary failure conditions relate to the access and use of wide-area networks, including the telephone, the cell phone, and the internet. The method and system monitors the three wide-area networks and sends warning messages if they cannot be accessed from a local site. The method and system redirects voice, text message, and data traffic via a detour over a different wide-area network in order to avoid the failure. In an alternate embodiment, the method and system is implemented with a standard personal computer with add-on boards or plug-ins.

FIG. 4 shows such an alternate embodiment with a minimum number of interfaces for a remote site. Such an alternate embodiment can be advantageous for remote sites:
A single remote site can support multiple local sites
Computers are easy to make relatively fault tolerant
The remote site may support additional functions related to the fault tolerant monitoring such as crisis response teams for medical or security alerts

In another alternate embodiment, using dedicated hardware with a micro controller and firmware, the hardware can be upgraded. Once cell phone service providers have adapted the third generation of GSM with UMST, HSUPA, and/or HSDPA, and once such radios are available as modules, the radios for the detour router can be upgraded to allow faster GPRS throughput in both directions. At this point it makes sense to upgrade the microcontroller for the 724 unit (50) and the network interface (54). The upgrade supports fail-safe operation with more traffic, such as for video cameras.

### Operation—Additional Embodiments

Using a personal computer, possibly with a server operating system, requires changes in the programming but not in the logic.

T. Utilizing UMST, HSUPA, and HSDPA allows much higher throughput over IP. Unlike operations based on earlier generation radios with GPRS/Edge, data service will always be available and not be displaced by voice calls over the cell phone.

Voice over IP allows even more redundancy for voice connection, singe the internet can be utilized as well as the cell phone. However, analog voice and call session control has to be converted into datagrams implementing the session initiation protocol (SIP) and digitization of the media stream.

### ADVANTAGES

If there is a fault in any one of three wide area networks, the users of this system are immediately notified, and the information is sent over an alternate wide area network. Traditional monitoring systems utilize only a single wide area network. The probability of an alarm or monitoring message not getting through in the fault-tolerant multi-network detour router system for text messages, data and voice is therefore greatly reduced. Furthermore, the system is designed to notify multiple recipients at the same time, thus reducing the probability of failure to notify and/or undue delays in notification. In security applications and for medical monitoring, where the consequences of missed notification can be drastic, the expected value of this fault-tolerant communication method is very high.

If there is a fault in the wide area communication, users of this system are immediately notified of the problem, and the system itself provides an alternate route for the information.

This method and system utilizes multiple communication channels with a fail-over scheme.

Traditional monitoring systems utilize a single communication network. This method and system utilizes multiple communication channels with a fail-over scheme.

The probability of an alarm or monitoring message not getting through is therefore greatly reduced. Furthermore, the system is designed to notify multiple recipients at the same time, thus reducing the probability of failure to notify and/or undue delays in notification. In security applications and for medical monitoring, where the consequences of missed notification can be drastic, the expected value of this fault-tolerant communication method is very high.

Operation is continuous, 24 hours a day, every day of the week, every week of the year. There are several operational environments that affect how the multi-network detour router system operates. The main focus is on the external environment that might invoke the fail-safe features of the multi-network detour router system. The main objective of the operation of the multi-network detour router system is to reduce the likelihood of a user not receiving some critical alarm or monitoring information.

### CONCLUSION, RAMIFICATIONS, AND SCOPE

The method and system disclosed conveys monitoring and alarm information to one or more recipients in a fault-tolerant manner. It ensures that critical monitoring information will not be lost due to wide area network outages. Cell phones are utilized, as well as telephones and the internet, to provide redundancy and fail-over opportunities for increased fault tolerance. The method has particular strengths in supporting communication even with dynamically assigned addresses.

The same method and approach can be used in security applications in which multiple services such as police and fire must be in regular contact. Additionally, it can be used for home-based medical monitoring, and can ensure that any changes in a patient's vital statistics are dependably broadcast despite faults in wide area network access. A strength of the system is that it has multiple avenues of contacting and informing users. Critical information can be conveyed to remote users, even when they're not in predictable locations.

The system is flexible and reconfigurable. It can be reconfigured remotely so that users can receive warning messages at cell phones that have just been replaced, and anticipated calls can filtered and selectively redirected to the users' cell phones.

We claim:

1. A method and system for using a text message over a cell phone network for interfacing between a remote user and data from and to local devices, comprising:
a method for acquiring data from an interface to a device and for sending data through said interface to said device through a loop or interrupt, where said interface is selected from a group including but not limited to:
circuitry for an interface to a cell phone, to set and detect the status of said cell phone, to dial and answer said cell phone, to send and receive text messages to and from said cell phone, and to send and receive datagrams to and from said cell phone
circuitry for an internet protocol network interface to the internet, to set and detect the status of the network interface, to manage network address translation, and to send and receive datagrams to and from an internet protocol network interface
circuitry to detect and report the status of alternating current power and uninterruptable power supply power availability
circuitry to detect and report the status of sensors through a sensor device interface
circuitry to set, detect and report the status of relays through a relay device interface
circuitry to send and receive data through an RS232 device interface, either directly or through a zigbee network
circuitry to send and receive data through an X10 device interface from X10 enabled devices
circuitry to set and detect the status of the public service telephone network at the interface between a house phone and the public switched telephone network
circuitry to read and write data to and from—memory/storage
a method for obtaining a set of rules pertaining to said interface and said data from memory/storage
a method for applying each of said rules for converting said data from said interface into a text message and an address, where said address is selected from a group consisting of but not limited to cell phone numbers, email addresses, internet protocol addresses with ports, and telephone numbers
a method, utilized if and only if said address is identified as a cell phone number, for sending said text message to said cell phone interface
a method, utilized if and only if said address is identified as an email address, for embedding said text message into an email and for sending said email to said email address through said internet protocol network interface
a method, utilized if and only if said address is identified as an internet protocol address with port, for sending said text message as datagram to said internet protocol address and port
a method for receiving a text message from the cell phone interface, for extracting the content of said received text message, and for extracting the originating telephone number
a method for obtaining a rule pertaining to said received text message from memory/storage, identifying data and an interface, applying said rule to convert said received text message into data, and sending said data to said interface
whereby changes in the current status of said interfaces and devices can be detected and converted into messages, whereby said messages or data to and from said interfaces can be routed over said local cell phone interface to specified remote users, whereby said text messages and data to said devices can be routed over said local cell phone interface, whereby control messages can be compared to the current status of said interfaces and devices, and whereby the status of said devices can be changed through said interfaces.

2. A method and system for detour routing of an outgoing text message to avoid failure in cell phone access, comprising:
a start-detour router method for outgoing text messages based on the method in claim 1, comprising:
checking the availability of the start-detour cell phone to send or receive text messages, and, if the status has changed, sending a notifying text message to the end-detour router
if said start-detour cell phone is available, sending the text message through said start-detour cell phone
if said start-detour cell phone is not available, concatenating the remote user's cell phone number with said text message, and sending said concatenated message through the internet to an internet protocol address and predetermined port of the end-detour system
said end-detour system receiving said concatenated message through the internet and through said predetermined port
said end-detour system separating said remote user's cell phone number from said text message
an end-detour router method based on the method in claim 1, comprising:
receiving said concatenated message through the internet and through said predetermined port
separating said remote user's cell phone number from said text message
sending said text message to said remote user's cell phone number through the end-detour cell phone
whereby outgoing text messages can be sent to the remote user's cell phone when the local cell phone is unavailable.

3. A method and system for detour routing of an incoming text messages from the remote user's cell phone to avoid failure, comprising:
an end-detour router at said local site, based on the method in claim 1, comprising:
checking the availability of the start-detour cell phone to receive a text message, and, if the status has changed, sending a notifying text message to the start-detour router
receiving said concatenated message through the internet and through said predetermined port
separating said remote user's cell phone number from said text message
sending said text message to said remote user's cell phone number through the end-detour cell phone
a start-detour router method based on the method in claim 1 that is remotely situated, comprising:
checking the availability of the end-detour cell phone to send or receive text messages
if said end-detour cell phone is available, concatenating the originator's cell phone number with said text message, and sending the text message through a start-detour cell phone to said end-detour cell phone
if said end-detour cell phone is not available, concatenating the originator's cell phone number with said text message, and sending said concatenated message through the internet to an internet protocol address and predetermined port of the end-detour system
whereby a remote user can send a text message to an end-detour router to ensure that the message is received by the start-detour router.

4. A method and system for detour routing of an exchange of datagrams from a local client on a local area network to a remote server on the internet over the cell phone data network, incorporating the method and system in claim 1, and comprising:
a method for receiving a datagram from a local area network address through said network interface
a method for applying network address translation to said outgoing datagram, with a port to allow routing returning packets to said local area network address
a method for sending said outgoing datagram over the cell phone data interface to the internet
a method for receiving an incoming datagram through the cell phone data interface from the internet
a method for assigning ports and applying network address translation to said exchange of datagrams so that returning packets are sent to said local area network address
a method for sending said returning datagrams through the network interface to said local area network address
whereby the exchange of datagrams from a local client on a local area network to a remote server on the internet is routed to the internet even when the local connection to the internet is not functional, and whereby packets returning to said local area network address are routed correctly.

5. A method and system for detour routing of an exchange of datagrams initiated by a remote client on the internet to a local server, incorporating the method and system of claim 4, and additionally comprising:
a method for constructing a table of unique port numbers for all local area network servers that may be accessed by remote clients on the internet such that said port numbers do not conflict with ports assigned to local clients,
sharing this table with both detour routers
enabling listening on said port numbers by a router interfacing with the internet, by a network interface in the detour router, and by the cell phone data interface in the detour router
a method for editing network address translation tables in the detour routers by adding the entries with the unique ports pointing to said local area network servers
a method in the detour routers for remotely editing network address translation tables in the internet to said local area network router by adding the entries with the unique ports pointing to said local area network servers
a method of checking the availability of the internet and of the address of the interface to the public internet, and of sending text messages indicating changes and current status to specified cell phone numbers
a method of initiating a cell phone data session on request from a remotely-situated start-detour router through a text message received by the cell phone
a remotely-situated start-detour router method for routing datagrams incorporating the method in claim 4, comprising:
a method for tracking the predicted time-out of an active cell phone data sessions, and for sending a request for activating cell phone data sessions
a method for receiving an incoming datagram through said internet interface from the internet using a port in said table of unique port numbers
a method for applying network address translation to said incoming datagram
a method for sending said incoming datagram through said cell phone data interface to said local area network
a method for receiving an outgoing datagram from said local area network through said network interface
a method for applying network address translation to said outgoing datagram
a method for sending said outgoing datagram over said cell phone data interface to the internet
a local end-detour router method for routing datagrams based on the method in claim 1 comprising:
a method for receiving an incoming datagram through said cell phone data interface from the remote start-detour router method
a method for applying network address translation to said incoming datagram, utilizing said unique port assignment
a method for sending said incoming datagram through said network interface to said local area network
a method for receiving an outgoing datagram from said local area network through said network interface
a method for applying network address translation to said outgoing datagram, incorporating said unique port assignments
a network for sending said outgoing datagram over said cell phone data interface to said remote start-detour router
whereby said unique ports are synchronized between said start-detour router and said end-detour router, and whereby remotely located clients on the internet can access servers on a local area network even when the internet cannot be accessed by an internet-to-local-area-network router from the local area network, or after the dynamically assigned address of said internet to local area network router has been changed.

6. A method and system for detour routing of telephone calls from and to local devices connected directly to the public switched telephone network to and from remote users over multiple networks, and under failure conditions, incorporating the method in claim 1, and comprising:
a method to detect a failure condition in the public switched telephone network failure condition
a method to disconnect and reconnect the internal telephone wiring from the public switched telephone network wiring
a method to provide electrical support to local telephone wiring while disconnected from the public switched telephone network
a method for call session control on said local telephone, including but not limited to detecting changes in the on-hook or off-hook condition of said local telephone, providing dial-tone capabilities, and detecting the telephone number dialed
a method for call-session control through said cell phone interface, including but not limited to detecting availability, initiating a call, detecting the remote termination of a call, terminating a call in response to an on-hook condition of a local telephone
a method for managing the audio media connection from the local telephone through said cell phone interface for both outgoing and incoming audio signal
a method to delay switching to the public switched telephone network until said detoured call is completed if the public switched telephone network becomes available during said call
whereby a locally originating telephone call can be connected even when the public switched telephone network is not locally available, and whereby said call can be terminated by either party.

7. A method and system for detour routing of telephone calls from and to local devices connected directly to the public switched telephone network to and from remote users over multiple networks, under failure conditions, incorporating the method in claim 1, and comprising:
a method to detect a failure condition in the public switched telephone network
a method to disconnect and reconnect the internal telephone wiring from the public switched telephone network wiring
a method to provide electrical support to local telephone wiring while disconnected from the public switched telephone network
a method for call-session control on said local telephone, including but not limited to detecting changes in the on-hook or off-hook condition of said local telephone, providing notification of incoming calls
a method for call session control through said cell phone interface, including detecting an incoming call and detecting the telephone number originating the call, detecting the remote termination of a call, terminating a call in response to an on-hook condition of a local telephone
a method for managing the audio-media connection from the local telephone through said cell phone interface for both outgoing and incoming audio signal
a method to delay switching to the public switched telephone network until said detoured call is completed if the public switched telephone network becomes available during said call
whereby an external caller has the option to call the cell phone telephone number and be connected through the house phone even when the public switched telephone network is not locally available.

8. A method and system for detour routing of telephone calls to local devices connected directly to the public switched telephone network from remote users over multiple networks, under failure conditions, incorporating the method in claim 1, and comprising:
a method to disconnect and reconnect internal-telephone wiring from the public switched telephone network wiring
a method to detect changes in the on-hook or off-hook condition of said local telephone
a method for call-session control on said local telephone, including but not limited to detecting an incoming call and detecting the telephone number originating the call
a method to retrieve a rule from memory that determines if said call should be forwarded through said cell phone interface to a telephone number supplied by said rule
a method for call-session control through said cell phone interface, including detecting availability, initiating a call, detecting the remote termination of a call, terminating a call in response to a termination of the incoming call over public switched telephone network
a method for managing the audio-media connection from the public switched telephone network through the cell phone interface for both outgoing and incoming audio signal
a method to reconnect the public switched telephone network to the local telephone wiring once said detoured call has completed
whereby selected externally-originating telephone calls from the public switched telephone network can be redirected to another telephone number via said cell phone, and whereby selection filtering and redirection can be modified from a remote cell phone with text messages.

9. A method and system for detour routing of text messages and datagrams originating from a local site to users, clients, or servers at a remote location, incorporating the methods in claim 2 and claim 4, and of text messages and datagrams originating from a remote location to devices, clients, or servers at a local site, incorporating the methods in claim 3 and claim 5, comprising:
a method for checking the availability of the cell phone network and of the internet at the local site
a method for reporting changes in said availability to the remote user and to the detour router at the remote site via text message
a method for normal routing and for detour routing of text messages and of datagram exchanges originating at said local site, where the methods for the start-detour router are integrated into a single system at the local site
a method for normal routing and for detour routing of text messages and of datagram exchanges originating at the remote site, where the methods for the end-detour router are integrated into said single system at the local site
whereby locally-originating text messages and datagram exchanges can succeed even when the normally-used network is unavailable at the local site, and whereby remotely-originating text messages and datagram exchanges can succeed even when the normally-used network is unavailable at the local site.

10. A method and system for detour routing of text messages, datagrams, and telephone calls originating from a local site to users, clients, or servers at a remote location, incorporating the methods in claim 6 and claim 9, of text messages, datagrams, and telephone calls originating from a remote location to users, clients, or servers at a local site, incorporating the methods in claim 9, claim 7, and claim 8, comprising:
a method for checking the availability of the cell phone network, the internet, and the public switched telephone network at the local site
a method for reporting changes in said availability to the remote user and to the detour router at the remote site via text message
a method for normal routing and for detour routing of text messages, datagram exchanges, and telephone calls originating at the local site, where the methods for the start-detour router are integrated into a single system at the local site, and the methods for the end-detour router are integrated into a single system at the remote site
a method for normal routing and for detour routing of text messages and of datagram exchanges originating remotely, where the methods for the end-detour router are integrated into said single system at the local site, and the methods for the start-detour router are integrated into said single system at the remote site
a method for telephone calls originating remotely to be routed normally or to be detoured through the cell phone at the local site
whereby locally-originating text messages can succeed even when the cell phone network is unavailable at the local site, whereby locally-originating datagram exchanges can succeed even when the internet is unavailable at the local site, whereby locally-originating telephone calls can succeed even when the public switched telephone network is unavailable at the local site, whereby remotely-originating text messages can succeed even when the cell phone network is unavailable at the local site, whereby remotely-originating datagram exchanges can succeed even when the internet is unavailable at the local site, whereby remotely-originating telephone calls can succeed even when the public switched telephone network is unavailable at the local site, and whereby remotely-originating telephone calls can be redirected over the cell phone under conditions selected by the user.
